(19) United States
(12) Patent Application Publication
(10) Pub. No.: US 2022/0271694 A1
(43) Pub. Date: Aug. 25, 2022

(54) RESISTIVE LOAD BANK SYSTEMS

(71) Applicant: Alliance North America, Inc., Cypress, CA (US)

(72) Inventors: Joseph Norris, Loveland, CO (US); Jack Harris, Lake Forest, CA (US); Thomas J. Caterina, Sun Lakes, AZ (US)

(21) Appl. No.: 17/668,579

(22) Filed: Feb. 10, 2022

Related U.S. Application Data
(60) Provisional application No. 63/147,848, filed on Feb. 10, 2021.

(51) Int. Cl. H02P 9/00; H02K 9/14; H02K 11/00

(52) U.S. Cl. CPC H02P 9/006; H02K 9/14; H02K 11/0094

(57) ABSTRACT

A load bank system is configured for providing a minimum load for a generator. The load bank system includes a resistive load bank, a relay, and a load bank controller. The resistive load bank is configured to provide a resistive load to a generator. The relay is configured to selectively engage the resistive load of the resistive load bank to the generator. The load bank controller is operable to control the relay such that the resistive load is engaged when a real load coupled to the generator is below a threshold load value. The load bank system may be arranged within a housing of the generator.

### CROSS REFERENCE TO RELATED APPLICATIONS

The present application claims the filing benefits of U.S. provisional application, Ser. No. 63/147,848, filed Feb. 10, 2021, which is hereby incorporated by reference herein in its entirety.

### FIELD OF THE INVENTION

The present invention is directed to load bank systems, and in particular to load bank systems for generators.

### BACKGROUND OF THE INVENTION

Generators are often driven by diesel engines. While a diesel engine provides an efficient driver for a generator, diesel engines are susceptible to wet stacking (i.e., when unburnt diesel fuel passes into the diesel exhaust system and produces an oily residue). Wet stacking happens when a diesel engine is running at a low percentage or proportion of its capacity. For example, a diesel engine coupled to a generator is susceptible to wet stacking when the generator it is driving has no load or only a minimal load coupled to it. When the generator is operating with no load or only a minimal load, the diesel engine is likely only idling, resulting in the risk of wet stacking because the diesel engine is not at a proper operating temperature (allowing unburnt fuel to escape into the diesel exhaust system). Diesel engines are most efficient when they are running at a sufficient percentage or proportion of their full capacity. When a diesel engine is running under a sufficient load, the diesel engine can run at an optimum operating temperature. To aid in the prevention of wet stacking of diesel engines coupled to generators, dummy loads or load banks can be applied to their generators. The load banks provide a load on the generator that is sufficient to prevent wet stacking of the generator's diesel engine.

### SUMMARY OF THE INVENTION

Embodiments of the present invention provide a system for managing an operational environment of a diesel engine driven generator. A load bank system provides for the elimination or reduction of loading issues on diesel engine driven generators. The load bank system includes a resistive load bank that provides a dummy load for the generator to ensure that the diesel engine is run with a sufficient load to ensure that the diesel engine is running at an optimum operating temperature, such that the diesel engine avoids wet stacking conditions. The resistive load bank includes a plurality of resistors in a configurable arrangement. The load bank system includes a load bank controller for configuring the plurality of resistors such that the resistive load bank provides a desired load percentage regardless of the voltage output of the generator.

A load bank system for eliminating or reducing loading issues that lead to wet stacking in accordance with an embodiment of the present invention, comprises a resistive load bank, a load bank controller, and a relay. The resistive load bank provides a resistive load to a generator. The relay is for selectively engaging the resistive load of the resistive load bank to the generator. The load bank controller controls the relay such that the resistive load is engaged when a real load coupled to the generator is below a threshold load value.

In another embodiment of the present invention, a load bank system configured to provide a minimum load to a generator includes a reconfigurable resistive array, a relay, a voltage sensor, and a load bank controller. The reconfigurable resistive array provides a resistive load to a generator. The relay is for selectively engaging the resistive load of the resistive array to the generator. The voltage sensor is for sensing a voltage output of the generator. The load bank controller controls the relay such that the resistive load is engaged when a real load coupled to the generator is below a threshold load value. The load bank controller receives a voltage output value from the voltage sensor. The load bank controller selectively reconfigures the resistive array as defined by the output voltage value, such that the resistive load provided to the generator is a set percentage value regardless of the output voltage value.

In a further embodiment of the present invention, a load bank system is configured to selectively provide a minimum load to a generator. The generator is enclosed within a housing. A cooling system for cooling the generator is arranged within the housing. The cooling system outputs fan-forced air to cool the generator. The cooling air exits the housing via an exhaust vent in the housing. The load bank system is positioned upon the exhaust vent.

In an aspect of the present invention, the load bank system is alternatively positioned within the housing and adjacent to the exhaust vent. The cooling air exits the housing via the exhaust vent after passing through, and cooling, the load bank system.

These and other objects, advantages, purposes, and features of the present invention will become apparent upon review of the following specification in conjunction with the drawings.

### BRIEF DESCRIPTION OF THE DRAWINGS

FIG. 1 is a block diagram of a load bank system in accordance with the present invention;

FIG. 2 is a block diagram of a load bank controller monitoring a voltage output in accordance with the present invention;

FIG. 3A is a perspective view of a load bank system in accordance with the present invention;

FIG. 3B is a close-up view of the load bank system of FIG. 3A;

FIG. 3C is a side view of the load bank system of FIG. 3A, illustrating an exemplary arrangement of resistors in the load bank system in accordance with the present invention;

FIGS. 3D and 3E are additional perspective views of the load bank system of FIG. 3A;

FIG. 3F is a top-down view of the load bank system of FIG. 3A illustrating another view of the exemplary arrangement of resistors in the load bank system in accordance with the present invention;

FIG. 4A is a perspective view of an alternative load bank system in accordance with the present invention;

FIG. 4B is a bottom-up view of the load bank system of FIG. 4A illustrating an arrangement of resistors in the load bank system in accordance with the present invention;

FIG. 4C is a side view of the load bank system of FIG. 4A illustrating an interior view of a load bank controller of the load bank system in accordance with the present invention;

FIG. 4D is another perspective view of the load bank system of FIG. 4A;

FIG. 5 is a block diagram of an exemplary generator and load bank arrangement in accordance with the present invention;

FIG. 6 is a block diagram of an alternative generator and load bank arrangement in accordance with the present invention;

FIGS. 7A and 7B are perspective top-down views of an exemplary generator and load bank arrangement in accordance with the present invention; and

FIGS. 8A and 8B are perspective side views of the generator and load bank arrangement of FIGS. 7A and 7B.

### DESCRIPTION OF THE PREFERRED EMBODIMENTS

Referring to the drawings and the illustrative embodiments depicted therein, a load bank system provides for the elimination or reduction of loading issues on diesel engine driven generators, such as, for example, EPA Tier 4F certified or compliant diesel engine driven mobile generators. Exemplary load bank systems may be assembled or fitted to portable prime power skid generators or trailer-mounted diesel generators and provide selective engagement of resistive load banks to provide “dummy loads” to their respective generators when a real load is below a threshold load value. Alternatively, the load bank systems may be arranged within a housing of the generator.

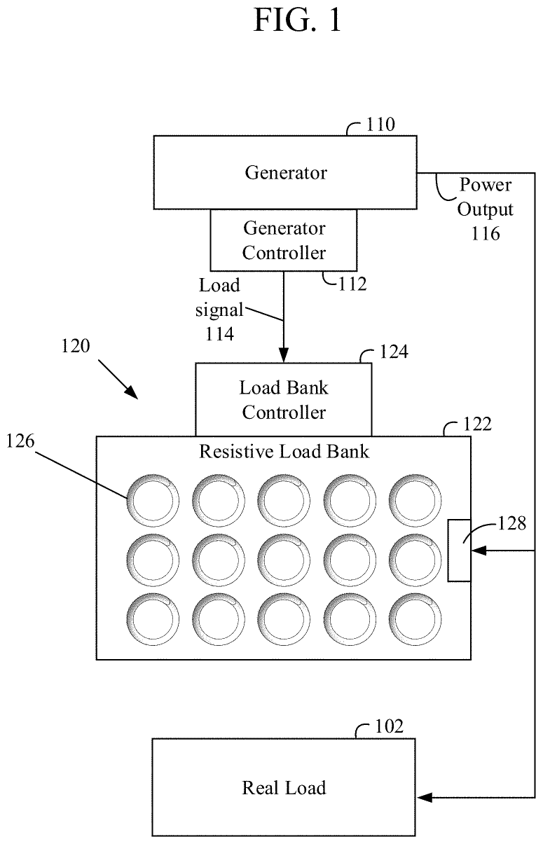

FIG. 1 illustrates a load bank system 120 that includes a resistive load bank 122 that absorbs energy from a diesel generator assembly 110 and allows the generator 110 to work under a loaded condition (even when there is no load or only a minimal load coupled to the generator 110) that is sufficient to prevent wet stacking when a variable real load 102 is too low to prevent wet stacking. Wet stacking can occur when the diesel engine is run below an optimal operating temperature. Optionally, the generator 110 is a portable generator (e.g., arranged or fitted to a skid or trailer). As illustrated in FIG. 1, the load bank system 120 and a real load 102 are both coupled to the power output 116 of the generator 110. While the circuit is simplified in FIG. 1, the load bank 120 and the real load 102 are arranged in a parallel circuit with the generator 110. Optionally, the generator 110 has a variable output voltage, e.g., 120V, 240V, and 480V.

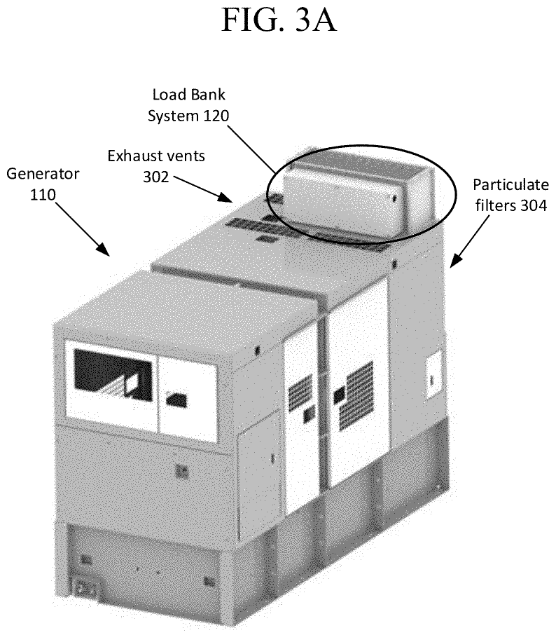

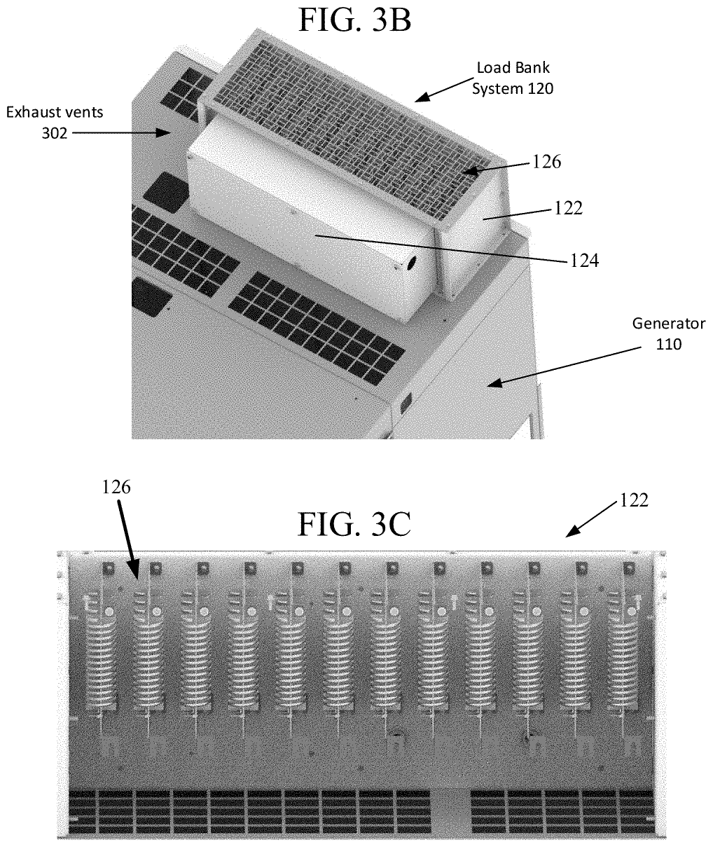

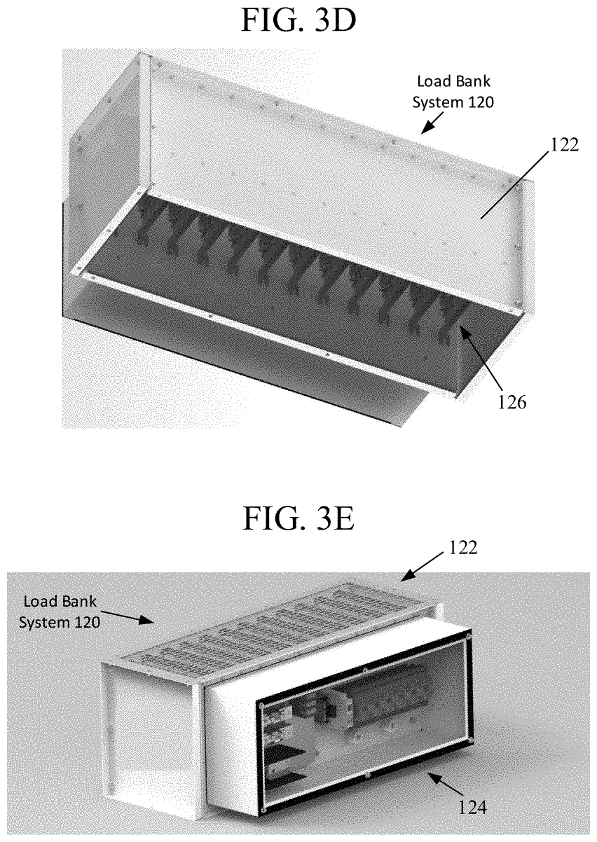

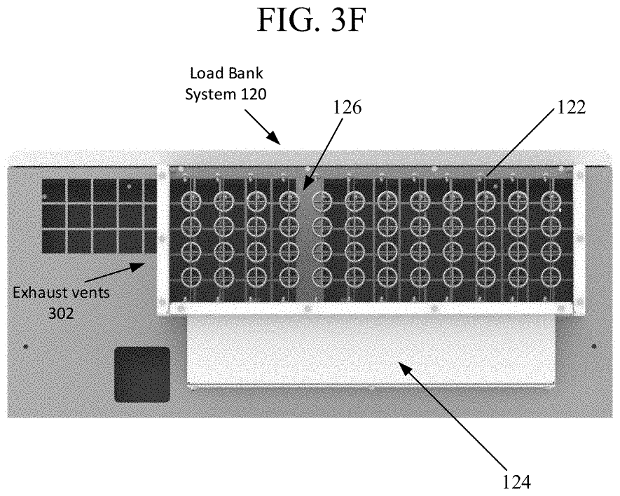

When the generator 110 is running without a real load 102 attached to its power output 116 (or when the attached real load 102 is a minimal load below a threshold (i.e., below 30%)), the load bank system 120 selectively provides a 30-40% load on the generator 110 that will keep the generator's engine exhaust and cooling system temperatures in an optimum operating range. The cooling system of the generator 110 includes fan-forced air cooling. The load bank system 120 includes a resistive load bank 122 and an associated controller 124 fitted to a diesel generator assembly 110 (see FIG. 3A). FIG. 1 illustrates an exemplary resistive load bank 122 and controller 124 coupled together.

FIGS. 3A and 3B illustrate an exemplary load bank system 120 positioned over cooling air exhaust vents 302 of an exemplary generator 110 (e.g., a diesel engine driven generator) for passive cooling of the load bank system 120. The generator's fan-forced cooling air exits the generator 110 via the exhaust vents 302. The load bank system 120 of FIG. 3B includes a resistive load bank 122 and a load bank controller 124. FIG. 3C is an interior view of an exemplary arrangement of resistors 126 in the resistive load bank 122. FIG. 3D is an underside view of the load bank system 120, illustrating the arrangement of resistors 126 in the resistive load bank 122. FIG. 3E illustrates the load bank controller 124 with an outer cover removed to reveal interior components (e.g., circuit breakers/fuses and wiring terminals). FIG. 3A illustrates the generator 110 optionally fitted with diesel particulate filters (DPFs) 304 in the diesel engine exhaust system. The DPFs 304 aid in further reducing emissions from the diesel engine by removing soot and ash from the exhaust gases of the diesel engine.

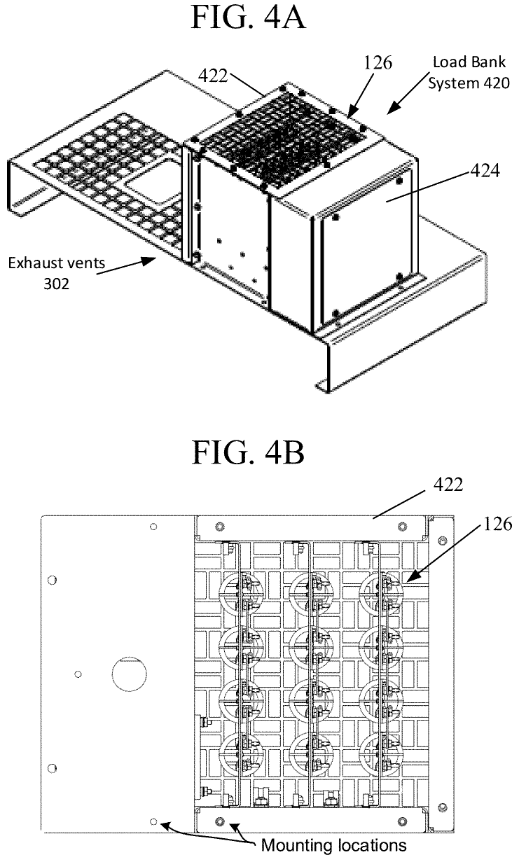

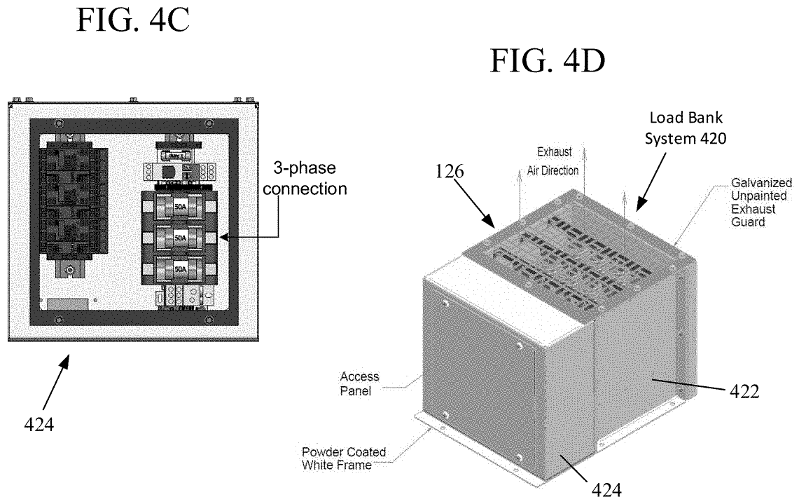

Positioning the load bank system 120, such that the resistive load bank 122 is positioned over the cooling-air exhaust vents 302 of the generator's cooling system, allows the cooling air as it exits the generator 110 to be used to passively cool the resistors 126 of the resistive load bank 122 (without any adaption or change in the generator's cooling system). As illustrated in FIGS. 3A, 3B, and 3F, the resistive load bank 122 positions an arrangement of resistors 126 above the exhaust vents 302 for cooling. FIGS. 4A, 4B, 4C, and 4D illustrate an alternative load bank system 420 that includes an alternative resistive load bank 422 with a different arrangement of resistors 126 as compared to the resistive load bank 122 (illustrated in FIGS. 3C and 3F). As illustrated in FIGS. 3B, 3D, 4C, and 4D, the housing of the resistive load bank 122, 422 does not include a bottom panel and only a minimal mesh top panel, such that the cooling air exiting the exhaust vent 302 can freely pass through the resistive load bank 122, 422 to cool the resistors 126. Embodiments of the load bank system 120, 420 are thus able to utilize cooling air exhaust vent cooling from an associated generator 110 in a variety of weather environments. An exemplary resistive load bank 122, 422 includes a plurality of resistors 126 that is arranged to allow for passive cooling from the generator's vented cooling air.

Each of the resistors 126 includes resistive materials in a desired arrangement. For example, the resistors 126 may be implemented as exemplary nickel chromium wire-wound resistors. As discussed herein, the resistive load bank 122 includes a variable number of resistors 126 arranged in a grid pattern that allows for individual mechanical supports and individual air cooling. As illustrated in FIG. 3C, the resistive load bank 122 includes an exemplary forty-eight (48) resistors 126. Alternatively, as illustrated in FIGS. 4A-4C, the resistive load bank 122 includes an exemplary twelve (12) resistors 126. As also illustrated in FIGS. 3C and 4A-4C, each of the resistors 126 is supported by mica insulators. For example, each resistor 126 may be supported by an arrangement of mica insulators on each side (of the resistor 126). The mica insulators provide a high-temperature tolerant insulation for the resistors 126. The mica insulators are an improvement over conventional ceramic supports, which are susceptible to breakdown, especially from vibrations on trailer-mounted load banks. Thus, the resistors 126 of the resistive load bank 122, 422 may be arranged and cooled such that the resistors 126 are prevented from overheating (e.g., the resistors 126 will be kept from heating to a point where they are visibly “red-hot” and susceptible to deformation and damage from overheating).

The alternative load bank system 420, illustrated in FIGS. 4A, 4B, 4C, and 4D, includes an alternative resistive load bank 422 comprising a different arrangement of resistors 126 (as compared to the resistive load bank 122). A load bank controller 424 is also illustrated coupled to the side of the resistive load bank 422. Functionally, the load bank controller 424 is the same as the load bank controller 124. However, as compared to the load bank system 120, the load bank controller 424 has different dimensions and is arranged along a different side of the resistive load bank 422. As illustrated in FIG. 4A, the alternative load bank system 420 is arranged on the cooling-air exhaust vents 302 of the generator 110 in a similar fashion as illustrated in FIGS. 3A and 3B. FIG. 4B is an underside view of the resistive load bank 422 illustrating mounting arrangements, as well as a bottom side view of the arrangement of resistors 126. FIG. 4C illustrates the load bank controller 424 with an outer cover removed to reveal interior components (e.g., circuit breakers/fuses and wiring terminals).

As illustrated in FIG. 1, the only control link between the generator 110 and the load bank controller 124 is a control signal 114 (also known as a “load signal”) output by the generator controller 112 and received by the load bank controller 124. As discussed herein, the load bank controller 124 will engage and disengage the resistive load bank 122 from the generator 110 based upon whether or not the load signal 114 has been received. The control signal or load signal 114 may be implemented as a 12 VDC customer supplied load demand signal that is output by the generator controller 112. The generator controller 112 monitors the generator's load output and outputs the load signal 114 in response to a determined percentage of load capacity. As illustrated in FIG. 1, a relay 128 in the resistive load bank 122 engages or disengages the resistive load bank 122 from the power output 116 of the generator 110. Optionally, the relay 128 may be a part of the load bank controller 124, 424. As also discussed herein, the load bank controller 124, after a delay period (e.g., a 5-minute delay), engages the resistive load bank 122. The delay period provides operational stability for the generator 110 and avoids nuisance starting and stopping of the load bank system 120.

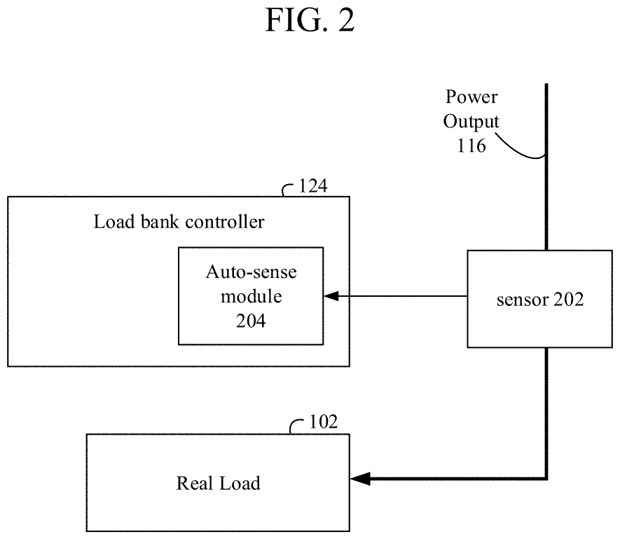

The load bank system 120 utilizes a single resistive value for the resistive load bank 122 as opposed to multiple, selective, resistive banks that may be selectively engaged to set a desired load value. In other words, engaging the resistive load bank 122 provides a set resistive value to the output of the generator 110 to apply a set load (e.g., a 30-40% load) on the generator 110. Thus, the load bank controller 124 of the load bank system 120, once activated, will energize the relay 128 to apply a resistive load, via the resistors 126 of the resistive load bank 122 (also known as a dummy load), to the output of the generator 110. The resistive load bank 122 provides an exemplary 40% load to the generator 110. Optionally, the resistive load bank 122 provides an exemplary 30% load to the generator 110. Other configurations are also possible such that the resistive load bank 122 will provide a resistive load of between 30-50% (in addition to any real load 102). Optionally, as discussed herein, the resistive load bank 122 includes reconfigurable circuits for arranging the resistive load bank 122 to provide a desired load for a variety of voltage outputs and conditions (see FIG. 2).

The load bank controller 124 of the load bank system 120 will apply the resistive load bank 122 to the generator 110 upon receiving the load signal 114 from the diesel generator controller 112. Upon receiving the load signal 114, the load bank controller 124 will delay five minutes before engaging the relay 128 to apply the resistive load bank 122 to the generator 110. The generator controller 112 outputs the load signal 114 if a real load 102 coupled to the generator 110 is determined to be less than 30% of the generator's load capacity (as determined by the generator controller 112). The load bank system 120 provides a dummy load of approximately 30-40% load, e.g., a 30% load or a 40% load, or some other selected load value. When the generator 110 is running without the real load 102 attached (or with a real load 102 that is zero or below a threshold load value), attaching the load bank system 120 (providing a 30-40% load) will keep the generator exhaust and cooling system temperatures in an optimum operating range.

Whenever the generator controller 112 determines that a combined real load 102 and dummy load (provided by the resistive load bank 122) are above a 75% load capacity of the generator 110, the generator controller 112 will immediately stop transmitting the load signal 114, such that the load bank controller 124 will immediately disengage the resistive load bank 122 from the generator 110. However, should the real load 102 fall to a load value of less than 30% of load capacity, the generator controller 112 will transmit the load signal 114 and the load bank controller 124 will reengage the resistive load bank 122 (after a five-minute delay by the load bank controller 124) and stay engaged until the combined load again exceeds 75% load capacity. This automatic operational state will continue until the load bank system 120 is turned off.

As illustrated in FIG. 2, in an alternative embodiment, the load bank controller 124 includes an “auto-sense” feature that senses the output voltage of the generator 110 and selects an arrangement for the resistive load bank 122 that produces the desired 30-40% load. As illustrated in FIG. 2, a sensor 202 monitors the voltage level of the power output 116 from the generator 110 and supplies a voltage signal to an auto-sense module 204. Based upon the sensed voltage of the power output 116 from the generator 110, the auto-sense module 204 selects a circuit arrangement for the resistors 126 of the resistive load bank 122. Thus, the load bank system 120 adapts to the supplied voltage output from the generator 110 to supply a consistent load percentage. Whether the output voltage from the generator 110 is, for example, 110V, 240V, or 480V, the resistive load bank 122 will be adapted to provide the desired 30-40% load.

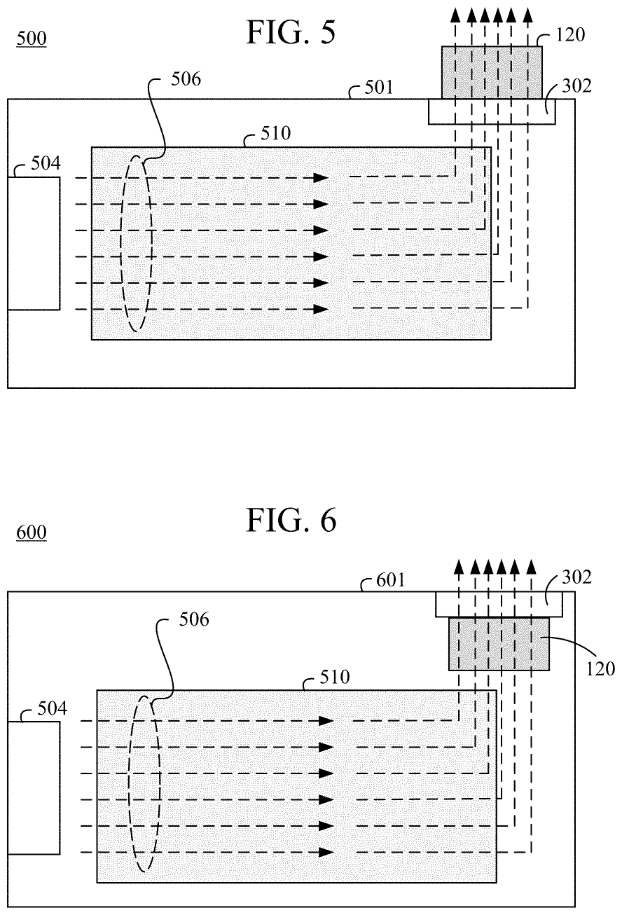

FIG. 5 illustrates an exemplary generator system 500 that includes a generator 510 arranged within a housing 501. A cooling system includes an air intake and fan arrangement 504 that draws in cooling air 506 to air cool the generator 510, and with an exhaust vent 302 for venting the cooling air from the housing 501. FIG. 5 illustrates a load bank system 120 arranged upon the housing 501 and over the exhaust vent 302. As illustrated in FIG. 5, the cooling air 506, in exiting the housing 501 via the exhaust vent 302, passes through and cools the load bank 120.

FIG. 6 illustrates an alternative generator system 600 that includes a generator 510 and a load bank 120 within a housing 601. As compared to the housing 501 for the generator system 500 of FIG. 5, the housing 601 of the alternative generator system 600 is configured to retain the load bank 120 within the housing 601. As illustrated in FIG. 6, the load bank 120 is positioned against (or adjacent to) the exhaust vent 302, such that the cooling air 506 (from the air intake and fan arrangement 504) in leaving the housing 601, passes through and cools the load bank 120 before exiting the housing 601 via the exhaust vent 302.

Additional hardware of the cooling system has been omitted from FIGS. 5 and 6 for the sake of clarity. For example, additional hardware to force the cooling air 506 through and around the generator 510 and to guide the cooling air 506 to the exhaust vent 302 has been omitted. The diesel engine exhaust system (including optional diesel particulate filter) is also omitted.

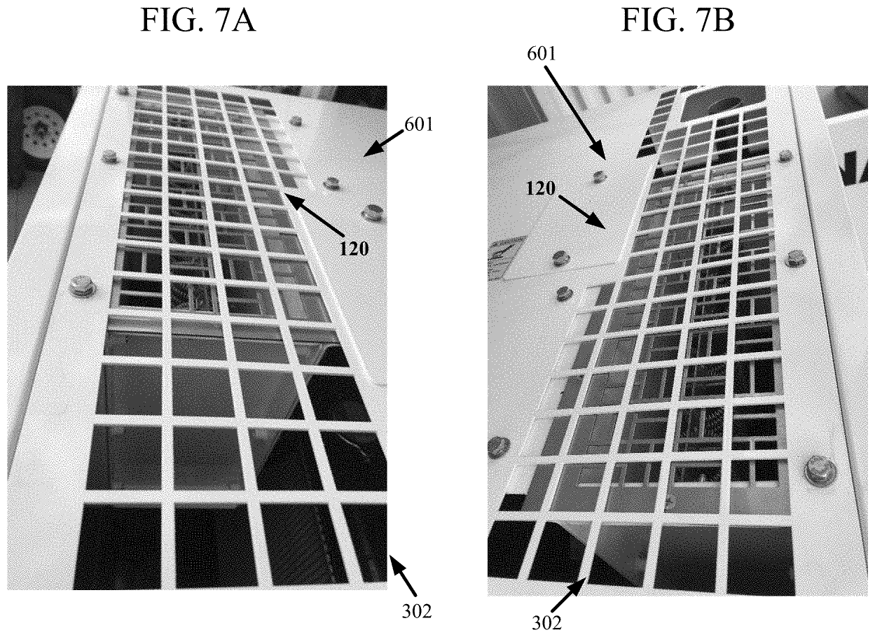

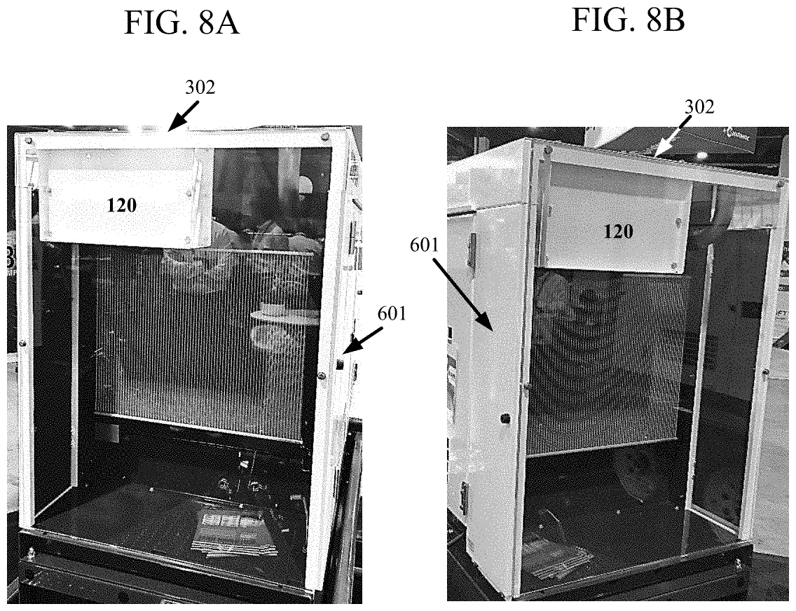

FIGS. 7A and 7B illustrate the placement of an exemplary load bank 120 within the housing 601 of the alternative generator system 600 of FIG. 6. As illustrated in FIGS. 7A and 7B, the load bank 120 is positioned immediately below the exhaust vent 302 of the housing 601. FIGS. 7A and 7B provide different perspective views of the load bank 120 with respect to the exhaust vent 302. FIGS. 8A and 8B provide additional views of the load bank 120 positioned within the housing 601. In FIGS. 8A and 8B, a side panel of the housing 601 of FIGS. 7A and 7B has been removed to provide another set of views of the orientation of the load bank 120 with respect to the housing 601 and the exhaust vent 302.

Thus, the exemplary embodiments discussed herein provide for the elimination or reduction of loading issues for diesel engine driven generators, such that their diesel engine drivers are prevented from operating under loading conditions that promote wet stacking. An exemplary load bank system includes a resistive load bank that is selected to provide a desired resistive load for an associated generator, such that the diesel engine driving the generator will be able to operate within a desired operational temperature range regardless of whether or not a real load is applied to the generator. A load bank controller of the load bank system engages the resistive load bank when a load on the generator is below a threshold load value. Alternative embodiments provide for the positioning of the load bank system either within a housing of the generator or upon the generator housing. Thus, the load bank system is either positioned adjacent to and before the exhaust vent, or adjacent to and above the exhaust vent.

Changes and modifications in the specifically described embodiments can be carried out without departing from the principles of the present invention which is intended to be limited only by the scope of the appended claims, as interpreted according to the principles of patent law including the doctrine of equivalents.

1. A load bank system configured to provide a minimum load to a generator, the load bank system comprising:
a resistive load bank configured to provide a resistive load to a generator;
a relay configured to selectively engage the resistive load of the resistive load bank to the generator; and
a load bank controller operable to control the relay such that the resistive load is engaged when a real load coupled to the generator is below a threshold load value.

2. The load bank system of claim 1, wherein the resistive load bank comprises a plurality of resistors configured to provide the resistive load.

3. The load bank system of claim 1, wherein the resistive load provides a 30-40% load on the generator.

4. The load bank system of claim 1, wherein the threshold load value is 30 percent of a maximum load capacity of the generator.

5. The load bank system of claim 1, wherein the load bank controller is operable to control the relay such that the resistive load is disengaged when a combination of the real load and the resistive load is above a maximum threshold load value.

6. The load bank system of claim 5, wherein the maximum threshold load value is 75 percent of a maximum load capacity of the generator.

7. The load bank system of claim 1 further comprising a voltage sensor configured to read an output voltage of the generator.

8. The load bank system of claim 7, wherein the load bank controller is configured to receive an output voltage value from the voltage sensor, and wherein the load bank controller is operable to configure the resistive load bank as defined by the output voltage value, such that the resistive load provided to the generator is a set percentage value regardless of the output voltage value.

9. The load bank system of claim 1, wherein the generator comprises a cooling system configured to cool the generator with fan-forced cooling air that exits via exhaust vents, and wherein the resistive load bank is positioned above the exhaust vents.

10. The load bank system of claim 9, wherein the generator is retained within a housing, wherein the exhaust vents are arranged on the housing, and wherein the resistive load bank is positioned upon the housing and above the exhaust vents.

11. The load bank system of claim 9, wherein the generator is retained within a housing, wherein the exhaust vents are arranged on the housing, and wherein the resistive load bank is retained within the housing and positioned adjacent to the exhaust vents, such that the cooling air passes through the resistive load bank before exiting via the exhaust vents.

12. A load bank system configured to provide a minimum load to a generator, the load bank system comprising:
a reconfigurable resistive array configured to provide a resistive load to a generator;
a relay configured to selectively engage the resistive load of the resistive array to the generator;
a voltage sensor configured to sense a voltage output of the generator; and
a load bank controller operable to control the relay such that the resistive load is engaged when a real load coupled to the generator is below a threshold load value, wherein the load bank controller is configured to receive a voltage output value from the voltage sensor, and wherein the load bank controller is operable to selectively reconfigure the resistive array as defined by the output voltage value, such that the resistive load provided to the generator is a set percentage value regardless of the output voltage value.

13. The load bank system of claim 12, wherein the resistive array comprises a plurality of resistors configured to provide the resistive load.

14. The load bank system of claim 12, wherein the resistive load provides a 30-40% load on the generator.

15. The load bank system of claim 12, wherein the threshold load value is 30 percent of a maximum load capacity of the generator.

16. The load bank system of claim 12, wherein the load bank controller is operable to control the relay such that the resistive load is disengaged when a combination of the real load and the resistive load is above a maximum threshold load value.

17. The load bank system of claim 16, wherein the maximum threshold load value is 75 percent of a maximum load capacity of the generator.

18. The load bank system of claim 12, wherein the generator comprises a cooling system configured to cool the generator with fan-forced cooling air that exits via exhaust vents, and wherein the resistive load bank is positioned above the exhaust vents.

19. The load bank system of claim 18, wherein the generator is retained within a housing, wherein the exhaust vents are arranged on the housing, and wherein the resistive load bank is positioned upon the housing and above the exhaust vents.

20. The load bank system of claim 18, wherein the generator is retained within a housing, wherein the exhaust vents are arranged on the housing, and wherein the resistive load bank is retained within the housing and positioned adjacent to the exhaust vents, such that the cooling air passes through the resistive load bank before exiting via the exhaust vents.
